(19) United States
(12) Patent Application Publication
(10) Pub. No.: US 2025/0274987 A1
(43) Pub. Date: Aug. 28, 2025

(54) APPARATUS FOR BACKSCATTERING COMMUNICATION

(71) Applicant: Nokia Technologies Oy, Espoo (FI)

(72) Inventors: Navin HATHIRAMANI, Dallas, TX (US); Ioannis KIMIONIS, Murray Hill, NJ (US); Howard HUANG, Murray Hill, NJ (US)

(21) Appl. No.: 18/863,435

(22) PCT Filed: May 30, 2022
(86) PCT No.: PCT/EP2022/064559

§ 371 Date: Nov. 6, 2024

(51) Int. Cl. H04W 74/0833; H04W 74/08

(52) U.S. Cl. CPC H04W 74/0833; H04W 74/0866

(57) ABSTRACT

An apparatus, comprising at least one processor, and at least one memory storing instructions, the at least one memory and the instructions configured to, with the at least one processor, cause an illuminator for illuminating at least one tag with a radio frequency signal to transmit an illuminator signal to the at least one tag based on a dedicated random access channel preamble associated with the illuminator.

### FIELD OF THE DISCLOSURE

Various example embodiments relate to an apparatus for backscattering communication.

Further embodiments relate to a method of operating related to such apparatus.

### BACKGROUND

In the context of at least some conventional communication networks, one important aspect is sustainability, which e.g. includes zero-energy communications. This term refers to terminal devices, e.g. end user devices, which operate without batteries but which may e.g. have energy harvesting capabilities (e.g. energy stored in a capacitor) or devices without batteries and no capability of storing energy.

One candidate technology for ultra-low energy or zero-energy devices are tags for receiving/transmitting radio frequency signals, e.g. backscatter tags, whereby a transmitter (or illuminator) sends a radio frequency signal which illuminates a tag. In some systems, a tag modulates an incoming radio frequency signal, e.g. with an information-bearing signal, e.g. by reflection, and the reflected signal may be received by a receiver.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus, comprising at least one processor, and at least one memory storing instructions, the at least one memory and the instructions configured to, with the at least one processor, cause an illuminator for illuminating at least one tag with a radio frequency signal to transmit an illuminator signal to the at least one tag based on a dedicated random access channel preamble associated with the illuminator. In some embodiments, this enables to provide the at least one tag with power, e.g. for at least temporarily powering an operation of the tag.

In some embodiments, the apparatus according to the embodiments or its functionality, respectively, may be used for or within wireless, e.g. cellular, communications systems, e.g. networks, based on or at least partially adhering to third generation partnership project, 3GPP, radio standards such as 5G (fifth generation), 5G-Advanced, 6G (sixth generation), or other radio access technology.

In some embodiments, the apparatus or its functionality, respectively, may be provided in a network device, of the communications system, for example in a base station, e.g. gNodeB (gNB).

In some embodiments, the apparatus or its functionality, respectively, may be provided in a terminal device, for example user equipment, of the communications system.

In some embodiments, the illuminator for illuminating the at least one tag may be a network device, e.g. gNB, or a terminal device, e.g. user equipment, for a wireless communication system.

In some embodiments, the illuminator may e.g. employ a random access channel (RACH), e.g. as determined by a base station of the wireless communication system, for illumination of the at least one tag.

In some embodiments, the illuminator may transmit the illuminator signal to the at least one tag on a resource, e.g. time and/or frequency resource, e.g. a subcarrier, e.g. of the wireless communication network, which is associated with the dedicated random access channel preamble.

In some embodiments, a plurality of illuminators may be provided, and at least some of the plurality of illuminators are provided with a dedicated random access channel preamble.

In some embodiments, the dedicated random access channel preamble is a geographically, e.g. spatially, dedicated random access channel preamble, i.e. not necessarily dedicated to one specific illuminator. In other words, in some embodiments, more than one illuminator may use one, e.g. geographically, e.g. spatially, dedicated, random access channel preamble, e.g. in a given area.

In some embodiments, the dedicated random access channel preamble is employed to power, e.g. energize, the at least one tag, which may e.g. be a passive tag, and, optionally, to inform a receiver network device, e.g. receiver base station, which may e.g. receive the dedicated random access channel preamble, of a start of a communication time frame of a particular illuminator.

In some embodiments, “passive tag” means that the tag is to be powered by a further entity different from the tag itself, e.g. by at least one illuminator providing at least one illuminator signal to the tag, to enable an operation of the tag.

In some embodiments, the instructions, when executed by the at least one processor, further cause the illuminator to receive from a network device e.g. the receiver base station, a first information characterizing at least one of: a) a configuration of random access channel resources, e.g. as characterized by allocated random access channel resources, b) the dedicated random access channel preamble associated with the illuminator. In some embodiments, this enables a network device such as e.g.

the receiver base station to instruct one or more illuminators which, e.g. dedicated, random access channel preamble to use for illuminating the at least one tag.

In some embodiments, e.g. alternatively or additionally to a network device instructing one or more illuminators which, e.g. dedicated, random access channel preamble to use for illuminating, such information may also be provided by configuration and/or standardization. In other words, in some embodiments, a dedicated random access channel preamble may be allocated or assigned, respectively, to at least one specific illuminator, e.g. in a static fashion.

In some embodiments, the instructions, when executed by the at least one processor, further cause the illuminator to transmit second information on a resource, e.g. time and/or frequency resource, e.g. of the wireless communication network, associated with the dedicated random access channel preamble associated with the illuminator.

In some embodiments, the second information may comprise or characterize an information signal, which, in some embodiments, may e.g. be modified by the at least one tag upon receipt at the tag, and a so modified information signal may e.g. be received by a network device such as e.g. a receiver network device, e.g. for evaluation and/or forwarding to at least one further entity, such as e.g. the illuminator.

In some embodiments, the instructions, when executed by the at least one processor, further cause the illuminator to receive third information, e.g. from a network device, e.g. the receiver network device, characterizing at least one of: a) a reception of the dedicated random access channel preamble associated with the illuminator by a network device, b) the second information, c) location information of at least one of the network device and the at least one tag.

Further exemplary embodiments relate to a method comprising: transmitting, by an illuminator for illuminating at least one tag with a radio frequency signal, an illuminator signal to the at least one tag based on a dedicated random access channel preamble associated with the illuminator.

Further exemplary embodiments relate to an apparatus comprising means for causing an illuminator for illuminating at least one tag with a radio frequency signal to transmit an illuminator signal to the at least one tag based on a dedicated random access channel preamble associated with the illuminator. In some embodiments, the means for causing the illuminator to transmit the illuminator signal may e.g. comprise at least one processor, and at least one memory storing instructions, the at least one memory and the instructions configured to, with the at least one processor, cause the illuminator to transmit the illuminator signal to the at least one tag.

Further exemplary embodiments relate to an apparatus, comprising circuitry to cause a tag for receiving a radio frequency signal to receive at least one illuminator signal from at least one illuminator for illuminating at least one tag with a radio frequency signal, wherein the at least one illuminator signal is based on a dedicated random access channel preamble associated with the at least one illuminator.

In some embodiments, the circuitry may e.g. comprise one or more analog components, e.g. non-integrated analog components.

In some embodiments, the circuitry may e.g. comprise at least one processor, and at least one memory storing instructions, the at least one memory and the instructions configured to, with the at least one processor, cause the tag to receive the at least one illuminator signal.

In some embodiments, the circuitry further causes the tag to use a power associated with, e.g. comprised by, the at least one illuminator signal for powering an operation of the tag.

In some embodiments, the circuitry further causes the tag to receive at least one information signal from the at least one illuminator, to modify the at least one information signal by applying at least one of a frequency shift and a modulation to the at least one information signal, and to transmit at least one modified information signal.

In some embodiments, the frequency shift may be based on a resource, e.g. time and/or frequency resource, e.g. a subcarrier, e.g. of the wireless communication network, which is associated with the dedicated random access channel preamble.

In other words, in some embodiments, the tag may receive the at least one information signal on a first resource, e.g. first subcarrier, and may apply a frequency shift to the at least one information signal to transmit the so obtained modified information signal in a second resource, e.g. second subcarrier, which is different from the first subcarrier. In some embodiments, this enables to use a frequency division multiplexing scheme which is e.g. compatible with the wireless communications network. In some embodiments, this enables the tag to receive the at least one information signal on the first resource, e.g. first subcarrier, while at the same time, for example at least partly temporally overlapping, transmitting the frequency shifted modified information signal using the second resource, e.g. second subcarrier.

In some embodiments, the abovementioned frequency shift may be configured such that it corresponds with a frequency resource granularity of the wireless communications network, e.g. in terms of subcarriers (or other frequency dimension resource units), the frequency shift e.g. corresponding to an integer multiple of a frequency range associated with one subcarrier (or other frequency dimension resource units).

In some embodiments, the abovementioned frequency shift may, for example also, depend on a configuration of the tag. In other words, in some embodiments, a first number of tags may e.g. effect a frequency shift by a first frequency offset, and a second number of tags may e.g. effect a frequency shift by a second frequency offset, the second frequency offset being different from the first frequency offset.

In some embodiments, the abovementioned frequency shift may, for example also, depend on the frequency resource, e. g. subcarrier, associated with the dedicated random access channel preamble.

Further exemplary embodiments relate to a method comprising: receiving, by a tag for receiving a radio frequency signal, at least one illuminator signal from at least one illuminator, wherein the at least one illuminator signal is based on a dedicated random access channel preamble associated with the at least one illuminator.

Further exemplary embodiments relate to an apparatus comprising means for causing a tag for receiving a radio frequency signal to receive at least one illuminator signal from at least one illuminator, wherein the at least one illuminator signal is based on a dedicated random access channel preamble associated with the at least one illuminator. In some embodiments, the means for causing the tag to receive at least one illuminator signal from at least one illuminator may e.g. comprise at least one processor, and at least one memory storing instructions, the at least one memory and the instructions configured to, with the at least one processor, cause the tag to receive the at least one illuminator signal from the at least one illuminator.

Further exemplary embodiments relate to an apparatus, comprising at least one processor, and at least one memory storing instructions, the at least one memory and the instructions configured to, with the at least one processor, cause a network device, e.g. receiving network device, to receive a modified information signal from at least one tag, wherein the modified information signal is based on at least one information signal transmitted from at least one illuminator for illuminating the at least one tag on a resource associated with a dedicated random access channel preamble associated with the at least one illuminator.

In some embodiments, the apparatus or its functionality, respectively, may be provided in a network device of the communications system, for example in a base station, e.g. gNodeB (gNB).

In some embodiments, using at least one illuminator, at least one tag and the network device, e.g. receiving network device, enables to provide a bi-static or multi-static architecture.

In some embodiments, the instructions, when executed by the at least one processor, further cause the network device to transmit third information characterizing at least one of: a) a reception of the dedicated random access channel preamble associated with the illuminator by a network device, e.g. the receiving network device, b) the second information, e.g. an information signal, or a signal derived from the information signal, e.g. a modified information signal, c) location information of at least one of the network device and the at least one tag to the at least one illuminator.

In some embodiments, the instructions, when executed by the at least one processor, further cause the network device to allocate random access channel resources and the at least one dedicated random access channel preamble to the at least one illuminator. This way, in some embodiments, the network device may control which illuminator uses which, for example dedicated, random access channel preamble.

In some embodiments, the instructions, when executed by the at least one processor, further cause the network device to transmit first information to the at least one illuminator, the first information characterizing at least one of: a) a configuration of random access channel resources, e.g. as characterized by allocated random access channel resources, b) the dedicated random access channel preamble associated with the illuminator.

In some embodiments, the instructions, when executed by the at least one processor, further cause the network device to perform at least one of: a) receiving a dedicated random access channel preamble on a first resource, e.g. first subcarrier, e.g. from at least one illuminator, b) receiving an information signal from the at least one illuminator on a second resource, e.g. second subcarrier, c) receiving a modified information signal from the at least one tag on a third resource, e. g. third subcarrier.

In some embodiments, at least two of the first resources, the second resources and the third resources at least partially overlap in at least one of a time dimension and a frequency dimension. In other words, in some embodiments, at least two of the first resources, the second resources and the third resources are not time and/or frequency multiplexed.

In some embodiments, the first, second and third resources need not be sequential, e.g. in terms of time, and may e.g. be overlapping in a time dimension, whereas the first, second and third resources are associated with different frequency resources, e.g. frequency ranges or channels, e.g. subcarriers, each.

Further exemplary embodiments relate to a method comprising: receiving, by a network device, a modified information signal from at least one tag, wherein the modified information signal is based on at least one information signal transmitted from at least one illuminator for illuminating the at least one tag on a resource associated with a dedicated random access channel preamble associated with the at least one illuminator.

Further exemplary embodiments relate to an apparatus comprising means for causing a network device to receive a modified information signal from at least one tag, wherein the modified information signal is based on at least one information signal transmitted from at least one illuminator for illuminating the at least one tag on a resource associated with a dedicated random access channel preamble associated with the at least one illuminator. In some embodiments, the means for causing the network device to receive the modified information signal from the at least one tag may e.g. comprise at least one processor, and at least one memory storing instructions, the at least one memory and the instructions configured to, with the at least one processor, cause the network device to receive the modified information signal from the at least one tag.

Further exemplary embodiments relate to a terminal device, e.g. user equipment, for a wireless communications network comprising at least one apparatus according to the embodiments. In some embodiments, the terminal device may at least temporarily operate as an illuminator for illuminating at least one tag with a radio frequency signal.

Further exemplary embodiments relate to a tag for receiving a radio frequency signal associated with a wireless communications network comprising at least one apparatus according to the embodiments.

Further exemplary embodiments relate to a network device, e.g. base station, e.g. gNB, for a wireless communications network comprising at least one apparatus according to the embodiments. In some embodiments, the network device may at least temporarily operate as an illuminator for illuminating at least one tag with a radio frequency signal. In some embodiments, the network device may at least temporarily operate as a receiving network device for receiving signals from at least one of a) an illuminator, b) a tag.

Further exemplary embodiments relate to a wireless communications network comprising at least one of: a) an apparatus according to the embodiments, b) a terminal device according to the embodiments, c) a tag according to the embodiments, d) a network device according to the embodiments.

### BRIEF DESCRIPTION OF THE FIGURES

FIG. 1 schematically depicts a simplified block diagram of an apparatus according to some embodiments,

FIG. 2 schematically depicts a simplified block diagram of an apparatus according to some embodiments,

FIG. 3 schematically depicts a simplified block diagram of an apparatus according to some embodiments,

FIG. 4 schematically depicts a simplified block diagram according to some embodiments,

FIG. 5 schematically depicts a simplified flow chart according to some embodiments,

FIG. 6 schematically depicts a simplified flow chart according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts a simplified flow chart according to some embodiments,

FIG. 11 schematically depicts a block diagram according to some embodiments,

FIG. 12 schematically depicts a diagram according to some embodiments,

FIG. 13 schematically depicts a diagram according to some embodiments,

FIG. 14 schematically depicts a simplified flow chart according to some embodiments,

FIG. 15 schematically depicts a simplified flow chart according to some embodiments,

FIG. 16 schematically depicts a simplified block diagram according to some embodiments,

FIG. 17 schematically depicts a simplified block diagram according to some embodiments,

FIG. 18 schematically depicts a simplified block diagram according to some embodiments.

### DESCRIPTION OF SOME EXEMPLARY EMBODIMENTS

Some exemplary embodiments, see for example FIG. 1, 4, 5, relate to an apparatus 100, comprising at least one processor 102, and at least one memory 104 storing instructions 106, the at least one memory 104 and the instructions 106 configured to, with the at least one processor 102, cause an illuminator 10 for illuminating at least one tag 20 with a radio frequency signal RFS to transmit 402 an illuminator signal IS to the at least one tag 20 based on a dedicated random access channel preamble D-RACH associated with the illuminator 10. In some embodiments, this enables to provide the at least one tag 20 with power, e.g. for at least temporarily powering an operation of the tag 20.

In some embodiments, the apparatus 100 according to the embodiments or its functionality, respectively, may be used for or within wireless communications systems 1, e.g. networks, based on or at least partially adhering to some accepted standard, such as e.g. third generation partnership project, 3GPP, radio standards such as 5G (fifth generation), 5G-Advanced, 6G (sixth generation), or other radio access technology.

In some embodiments, FIG. 4, the apparatus 100 or its functionality, respectively, may be provided in a terminal device 10′, for example user equipment 10″, of the communications system 1.

In some embodiments (not shown), the apparatus 100 or its functionality, respectively, may be provided in a network device 30 of the communications system, for example in a base station, e.g. gNodeB (gNB) 30′.

In some embodiments (not shown), the illuminator for illuminating the at least one tag 20 may be a network device, e.g. gNB, or a terminal device, e.g. user equipment, for a wireless communication system.

In some embodiments, FIG. 4, the illuminator 10 may e.g. employ a random access channel (RACH), e.g. as determined by a base station 30 of the wireless communication system 1, for illumination of the at least one tag 20.

In some embodiments, FIG. 4, the illuminator 10 may transmit the illuminator signal IS to the at least one tag 20 on a resource, e.g. time and/or frequency resource, e.g. a subcarrier, e.g. of the wireless communication network 1, which is associated with the dedicated random access channel preamble D-RACH.

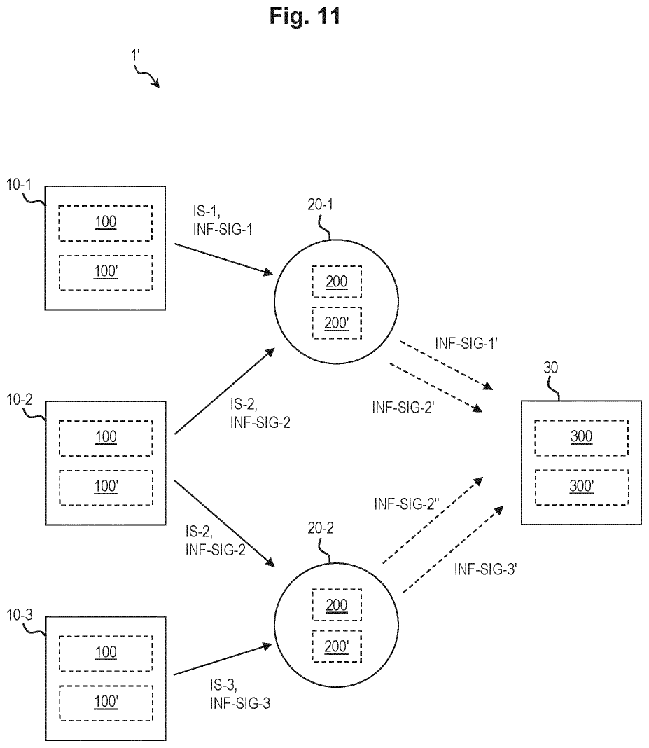

In some embodiments, FIG. 11, a plurality of illuminators 10-1, 10-2, 10-3 may be provided, and at least some of the plurality of illuminators 10-1, 10-2, 10-3 are provided with a dedicated random access channel preamble. Further details related to the plurality of illuminators 10-1, 10-2, 10-3 are explained further below with reference to FIG. 11.

In some embodiments, FIG. 4, the dedicated random access channel preamble D-RACH is a geographically, e.g. spatially, dedicated random access channel preamble, i.e. not necessarily dedicated to one specific illuminator. In other words, in some embodiments, more than one illuminator may use one, e.g. geographically dedicated, random access channel preamble D-RACH, e.g. in a given area.

In some embodiments, FIG. 4, the dedicated random access channel preamble D-RACH is employed to power, e.g. energize, the at least one tag 20, which may e.g. be a passive tag, and, optionally, to inform a receiver network device 30, e.g. receiver base station 30′, which may e.g. also receive the dedicated random access channel preamble D-RACH, of a start of a communication time frame of a particular illuminator 10.

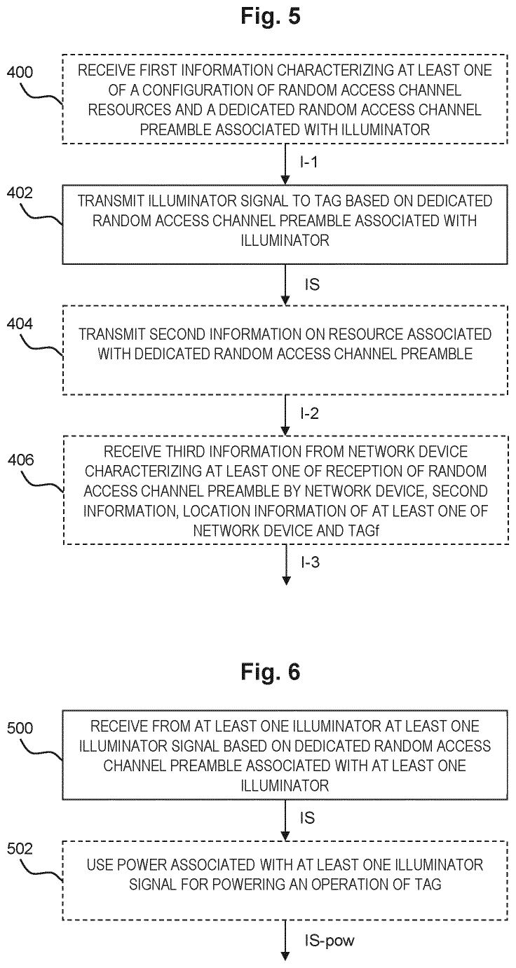

In some embodiments, the instructions 106, when executed by the at least one processor 102, further cause the illuminator 10 to receive 400 (FIG. 5) from a network device 30, e.g. the receiver base station 30′, a first information I-1 characterizing at least one of: a) a configuration of random access channel resources, e.g. as characterized by allocated random access channel resources, b) the dedicated random access channel preamble D-RACH associated with the illuminator 10. In some embodiments, this enables a network device 30 such as e.g. the receiver base station 30′ to instruct one or more illuminators 10 which, e.g. dedicated, random access channel preamble D-RACH to use for illuminating 402 the at least one tag 20.

In some embodiments, e.g. alternatively or additionally to a network device 30 instructing one or more illuminators 10 which, e.g. dedicated, random access channel preamble to use for illuminating, such information may also be provided by configuration and/or standardization. In other words, in some embodiments, a dedicated random access channel preamble D-RACH may be allocated or assigned, respectively, to at least one specific illuminator 10, e.g. in a static fashion.

In some embodiments, FIG. 5, the instructions 106, when executed by the at least one processor 102, further cause the illuminator 10 to transmit 404 second information I-2 (FIG. 4) on a resource, e. g. time and/or frequency resource, e. g. subcarrier, e.g. of the wireless communication network 1, associated with the dedicated random access channel preamble D-RACH, which is associated with the illuminator 10.

In some embodiments, the second information I-2 may comprise or characterize an information signal INF-SIG, which, in some embodiments, may e.g. be modified and transmitted, e.g. scattered, e.g. backscattered, by the at least one tag 20 upon receipt at the tag 20, and a so modified information signal INF-SIG′ may e.g. be received by a network device 30 such as e.g. a receiver network device 30′, e.g. for evaluation and/or forwarding to at least one further entity, such as e.g. the illuminator 10.

In some embodiments, FIG. 5, the instructions 106, when executed by the at least one processor 102, further cause the illuminator 10 to receive 406 third information I-3, e.g. from a network device 30, e.g. the receiver network device 30′, characterizing at least one of: a) a reception of the dedicated random access channel preamble D-RACH associated with the illuminator 10 by a network device 30, b) the second information I-2 (e.g., the information signal INF-SIGNAL or the modified information signal INF-SIG′), c) location information of at least one of the network device 30 and the at least one tag 20.

Further exemplary embodiments, FIG. 5, relate to a method comprising: transmitting 402, by an illuminator 10 for illuminating at least one tag 20 with a radio frequency signal RFS, an illuminator signal IS to the at least one tag 20 based on a dedicated random access channel preamble D-RACH associated with the illuminator 10.

Further exemplary embodiments, FIG. 16, relate to an apparatus 100′ comprising means 102′ for causing an illuminator 10 for illuminating at least one tag 20 with a radio frequency signal to transmit an illuminator signal IS to the at least one tag 20 based on a dedicated random access channel preamble D-RACH associated with the illuminator 10. In some embodiments, the means 102′ for causing the illuminator to transmit the illuminator signal may e.g. comprise at least one processor 102, and at least one memory 104 storing instructions 106, the at least one memory 104 and the instructions 106 configured to, with the at least one processor 102, cause the illuminator 10 to transmit 402 the illuminator signal IS to the at least one tag 20.

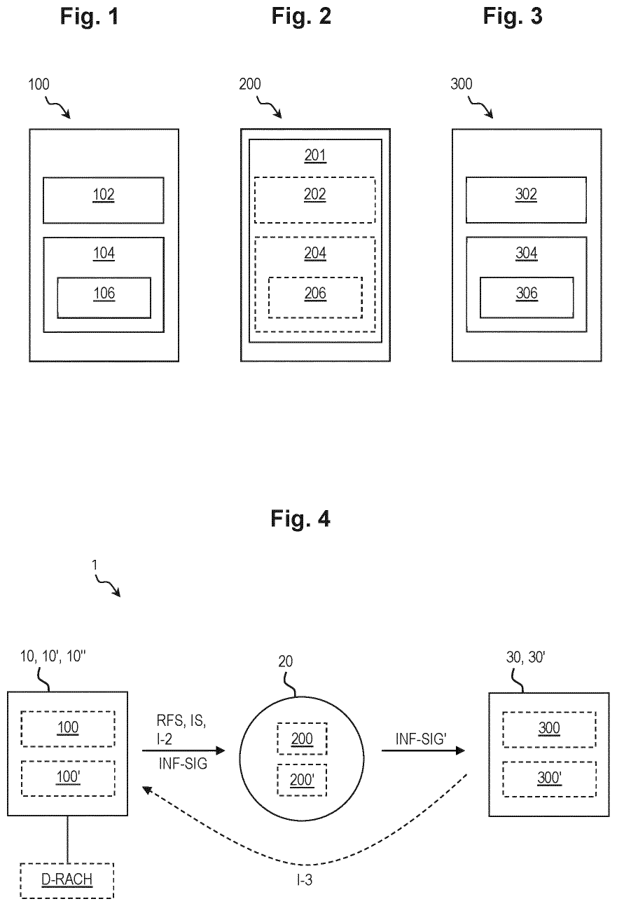

Further exemplary embodiments, FIG. 2, 4, 6, relate to an apparatus 200, comprising circuitry 201 configured to cause a tag 20 (FIG. 4) for receiving a radio frequency signal RFS to receive 500 at least one illuminator signal IS from at least one illuminator 10 for illuminating at least one tag with a radio frequency signal, wherein the at least one illuminator signal IS is based on a dedicated random access channel preamble D-RACH associated with the at least one illuminator 10.

In some embodiments, the circuitry 201 may e.g. comprise one or more analog components, e.g. purely analog components, e.g. non-integrated analog components.

In some embodiments, the circuitry 201 may e.g. comprise at least one processor 202, and at least one memory 204 storing instructions 206, the at least one memory 204 and the instructions 206 configured to, with the at least one processor 202, cause the tag 20 to receive 500 the at least one illuminator signal IS.

In some embodiments, a combination of one or more analog components, e.g. purely analog components, and a processor 202 with memory 204 and instructions 206 is also possible.

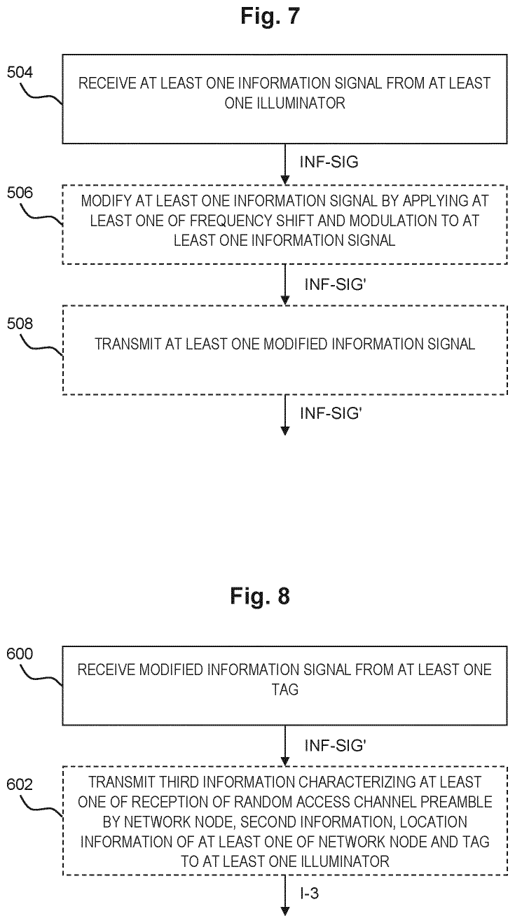

In some embodiments, FIG. 6, the circuitry 201 or the instructions 206, when executed by the at least one processor 202, further cause the tag 20 to use 502 a power IS-pow associated with, e.g. comprised by, the at least one illuminator signal IS for powering an operation of the tag, e.g. according to at least one of the blocks 504, 506, 508 of FIG. 7.

In some embodiments, FIG. 7, the circuitry 201 or the instructions 206, when executed by the at least one processor 202, further cause the tag 20 to receive 504 at least one information signal INF-SIG (e.g., characterized by the second information I-2 of FIG. 4) from the at least one illuminator 10, and, optionally, to modify 506 the at least one information signal INF-SIG by applying 506 at least one of a frequency shift and a modulation to the at least one information signal INF-SIG, whereby a modified information signal INF-SIG′ is obtained, and, optionally, to transmit 508 the at least one modified information signal INF-SIG′. In some embodiments, the transmitting 508 is done via scattering, e.g. backscattering, the modified information signal INF-SIG′.

In some embodiments, the frequency shift may be based on a resource, e.g. time and/or frequency resource, e.g. a subcarrier, e.g. of the wireless communication network 1, which is associated with the dedicated random access channel preamble D-RACH.

In other words, in some embodiments, the tag 20 may receive 504 the at least one information signal INF-SIG on a first resource, e.g. first subcarrier, and may apply a frequency shift to the at least one information signal INF-SIG to transmit 508 the so obtained modified information signal INF-SIG′ in a second resource, e.g. second subcarrier, which is different from the first subcarrier. In some embodiments, this enables to use a frequency division multiplexing scheme which may e.g. be compatible with the wireless communications network 1. In some embodiments, this enables the tag 20 to receive 504 the at least one information signal INF-SIG on the first resource, e.g. first subcarrier, while at the same time, for example at least partly temporally overlapping, transmitting 508 the frequency shifted modified information signal INF-SIG′ using the second resource, e.g. second subcarrier.

In some embodiments, the abovementioned frequency shift may be configured such that it corresponds with a frequency resource granularity of the wireless communications network 1, e.g. in terms of subcarriers (or other frequency dimension resource units or partitioning, respectively), the frequency shift e.g. corresponding to an integer multiple of a frequency range associated with one subcarrier (or other frequency dimension resource units).

In some embodiments, the abovementioned frequency shift may, for example also, depend on a configuration of the tag 20. In other words, in some embodiments, a first number of tags may e.g. effect a frequency shift by a first frequency offset, and a second number of tags may e.g. effect a frequency shift by a second frequency offset, the second frequency offset being different from the first frequency offset.

In some embodiments, the abovementioned frequency shift may, for example also, depend on the frequency resource, e.g. subcarrier, associated with the dedicated random access channel preamble D-RACH.

Further exemplary embodiments, FIG. 6, relate to a method comprising: receiving 500, by a tag 20 for receiving a radio frequency signal, at least one illuminator signal IS from at least one illuminator 10, wherein the at least one illuminator signal IS is based on a dedicated random access channel preamble D-RACH associated with the at least one illuminator 10.

Further exemplary embodiments, FIG. 17, relate to an apparatus 200′ comprising means 202′ for causing a tag 20 for receiving a radio frequency signal to receive 500 at least one illuminator signal IS from at least one illuminator 10, wherein the at least one illuminator signal IS is based on a dedicated random access channel preamble D-RACH associated with the at least one illuminator 10. In some embodiments, the means 202′ for causing the tag 20 to receive 500 at least one illuminator signal IS from at least one illuminator 10 may e.g. comprise at least one processor 202, and at least one memory 204 storing instructions 206, the at least one memory 204 and the instructions 206 configured to, with the at least one processor 202, cause the tag 20 to receive 500 the at least one illuminator signal IS from the at least one illuminator 10.

Further exemplary embodiments, FIG. 3, 4, 8, relate to an apparatus 300, comprising at least one processor 302, and at least one memory 304 storing instructions 306, the at least one memory 304 and the instructions 306 configured to, with the at least one processor 302, cause a network device 30, e.g. receiving network device 30′, to receive 600 a modified information signal INF-SIG′ from at least one tag 20, wherein the modified information signal INF-SIG′ is based on at least one information signal INF-SIG transmitted from at least one illuminator 10 for illuminating the at least one tag 20 on a resource associated with a dedicated random access channel preamble D-RACH associated with the at least one illuminator 10.

In some embodiments, the apparatus 300 or its functionality, respectively, may be provided in a network device 30 of the communications system 1, for example in a base station, e.g. gNodeB (gNB) 30′.

In some embodiments, FIG. 4, using at least one illuminator 10, at least one tag 20 and the network device 30, e.g. receiving network device, enables to provide a bi-static or multi-static architecture, wherein information signals INF-SIG may be modified by the at least one tag 20 and may be transmitted, e.g. backscattered, as modified, e.g. frequency shifted, information signals INF-SIG′, wherein time and/or frequency resources of the wireless communication network 1 such as e.g. subcarriers may be used for transmitting the signals INF-SIG, INF-SIG′, as well as for illuminating signals IS.

In some embodiments, FIG. 8, the instructions 306, when executed by the at least one processor 302, further cause the network device 30 to transmit 602 third information I-3 characterizing at least one of: a) a reception of the dedicated random access channel preamble D-RACH associated with the illuminator 10 by a network device, e.g. the receiving network device, 30, b) the second information I-2, e.g. an information signal INF-SIG, or a signal derived from the information signal INF-SIG, e.g. a modified information signal INF-SIG′, c) location information of at least one of the network device 30 and the at least one tag 20, to the at least one illuminator 10. In some embodiments, this way, the illuminator 10 may be provided with information on, e.g. associated with, e.g. the modified information signal INF-SIG′, even if the illuminator 10 itself does not receive or decode the modified information signal INF-SIG′.

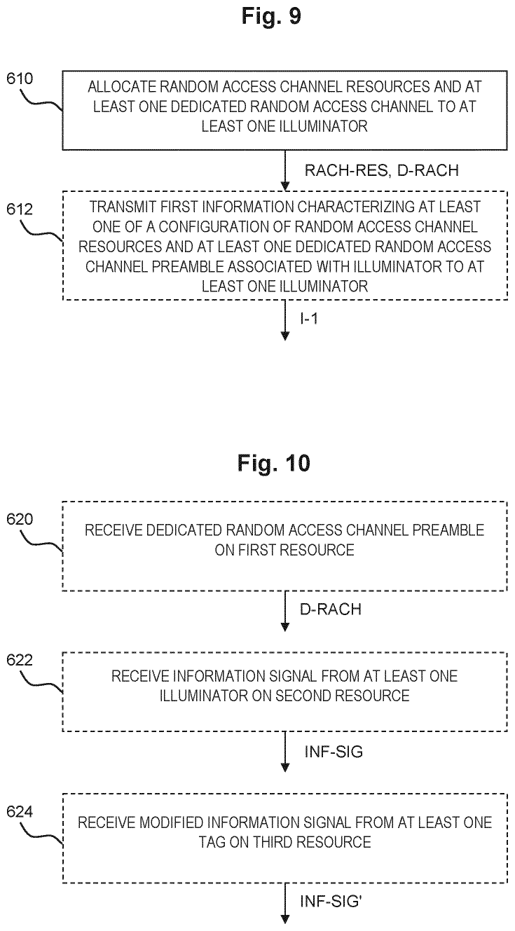

In some embodiments, FIG. 9, the instructions 306, when executed by the at least one processor 302, further cause the network device 30 to allocate 610 random access channel resources RACH-RES and the at least one dedicated random access channel preamble D-RACH to the at least one illuminator 10. This way, in some embodiments, the network device 30 may control which illuminator uses which, for example dedicated, random access channel preamble D-RACH.

In some embodiments, FIG. 9, the instructions 306, when executed by the at least one processor 302, further cause the network device 30 to transmit 612 the first information I-1 to the at least one illuminator 10, the first information I-1 characterizing at least one of: a) a configuration of random access channel resources RACH-RES, e.g. as characterized by allocated random access channel resources, b) the dedicated random access channel preamble D-RACH associated with the illuminator 10.

In some embodiments, FIG. 10, the instructions 306, when executed by the at least one processor 302, further cause the network device 30 (FIG. 4) to perform at least one of: a) receiving 620 a dedicated random access channel preamble D-RACH on a first resource, e.g. first subcarrier, e.g. from at least one illuminator 10, b) receiving 622 (FIG. 10) an information signal INF-SIG from the at least one illuminator 10 on a second resource, e.g. second subcarrier, c) receiving 624 a modified information signal INF-SIG′ from the at least one tag 20 on a third resource, e.g. third subcarrier.

In some embodiments, the first, second and third resources need not be sequential, e.g. in terms of time, and may e.g. be overlapping in a time dimension, whereas the first, second and third resources are associated with different frequency resources, e. g. frequency ranges or channels, e.g. subcarriers, each.

In some embodiments, at least two of the first resources, the second resources and the third resources at least partially overlap in at least one of a time dimension and a frequency dimension. In other words, in some embodiments, at least two of the first resources, the second resources and the third resources are not time and/or frequency multiplexed.

Further exemplary embodiments, FIG. 8, relate to a method comprising: receiving 600, by a network device 30, a modified information signal INF-SIG′ from at least one tag 20, wherein the modified information signal INF-SIG′ is based on at least one information signal INF-SIG transmitted from at least one illuminator 10 for illuminating the at least one tag on a resource associated with a dedicated random access channel preamble D-RACH associated with the at least one illuminator 10.

Further exemplary embodiments, FIG. 18, relate to an apparatus 300′ comprising means 302′ for causing a network device 30 to receive 600 a modified information signal INF-SIG′ from at least one tag 20, wherein the modified information signal INF-SIG′ is based on at least one information signal INF-SIG transmitted from at least one illuminator 10 on a resource associated with a dedicated random access channel preamble D-RACH associated with the at least one illuminator 10. In some embodiments, the means 302′ for causing the network device 30 to receive 600 the modified information signal INF-SIG′ from the at least one tag 20 may e.g. comprise at least one processor 302, and at least one memory 304 storing instructions 306, the at least one memory 304 and the instructions 306 configured to, with the at least one processor 302, cause the network device 30 to receive 600 the modified information signal INF-SIG′ from the at least one tag 20.

Further exemplary embodiments, FIG. 4, relate to a terminal device 10′, e.g. user equipment 10″, for a wireless communications network 1 comprising at least one apparatus 100, 100′ according to the embodiments. In some embodiments, the terminal device 10′ may at least temporarily operate as an illuminator 10 for illuminating at least one tag 20 with a radio frequency signal RFS.

Further exemplary embodiments, FIG. 4, relate to a tag 20 for receiving a radio frequency signal RFS associated with a wireless communications network 1 comprising at least one apparatus 200, 200′ according to the embodiments.

Further exemplary embodiments, FIG. 4, relate to a network device 30, e.g. base station 30′, e.g. gNB, for a wireless communications network 1 comprising at least one apparatus 300, 300′ according to the embodiments. In some embodiments, the network device 30 may at least temporarily operate as an illuminator (not shown) for illuminating at least one tag 20 with a radio frequency signal.

In some embodiments, FIG. 4, the network device 30 may at least temporarily operate as a receiving network device for receiving signals IS, I-2, INF-SIG, INF-SIG′ from at least one of a) an illuminator 10, b) a tag 20.

Further exemplary embodiments, FIG. 4, relate to a wireless communications network 1 comprising at least one of: a) an apparatus 100, 100′, 200, 200′, 300, 300′ according to the embodiments, b) a terminal device 10′ according to the embodiments, c) a tag 20 according to the embodiments, d) a network device 30 according to the embodiments.

FIG. 11 schematically depicts a block diagram according to further exemplary embodiments. Depicted is a wireless communication network 1′ exemplarily comprising three illuminators 10-1, 10-2, 10-3, e.g. similar or identical to illuminator 10 of FIG. 4, two tags 20-1, 20-2, e.g. similar or identical to tag 20 of FIG. 2, and a network device, e.g. base station, 30, e.g. similar or identical to network device 30 of FIG. 4.

In some embodiments, illuminator 10-1 illuminates tag 20-1 with an illuminator signal IS-1, illuminator 10-2 illuminates tags 20-1, 20-2 with an illuminator signal IS-2, and illuminator 10-3 illuminates tag 20-2 with an illuminator signal IS-3, e.g. for at least one of powering up and energizing the tags 20-1, 20-2.

In some embodiments, illuminator 10-1 transmits a first information signal INF-SIG-1 to tag 20-1 in a first subcarrier, and tag 20-1 transmits, e.g. by backscattering, a modified first information signal INF-SIG-1′, which may e.g. be frequency shifted, in a second subcarrier, which is different from the first subcarrier, to the network device 30.

In some embodiments, illuminator 10-2 transmits a second information signal INF-SIG-2 to tags 20-1, 20-2 in a third subcarrier, tag 20-1 transmits, e.g. by backscattering, a modified second information signal INF-SIG-2′, which may e.g. be frequency shifted, in a fourth subcarrier, which is different from the third subcarrier, to the network device 30, and tag 20-2 transmits, e.g. by backscattering, a further modified second information signal INF-SIG-2″, which may e.g. be frequency shifted, e.g. either in a fifth subcarrier, which is different from the third and fourth subcarrier, or in the fourth subcarrier, to the network device 30.

In some embodiments, illuminator 10-3 transmits a third information signal INF-SIG-3 to tag 20-2 in a sixth subcarrier, and tag 20-2 transmits, e.g. by backscattering, a modified third information signal INF-SIG-3′, which may e.g. be frequency shifted, in a seventh subcarrier, which is different from the sixth subcarrier, to the network device 30.

In some embodiments, at least one of the tags 20-1, 20-2 may be a synchronous tag or an asynchronous tag.

In some embodiments, synchronous tags may be configured to achieve radio frequency synchronization, e.g., between a received information signal and an operation of the tag, e.g. for the purpose of a wireless protocol. In some embodiments, a synchronous tag may comprise a radio frequency receiver (not shown) and/or other means (such as, e.g., a local, for example precise, time-keeping entity, e.g. for stay-alive units).

In some embodiments, an asynchronous tag either a) does not incorporate or comprise a receiver or b) does not utilize such optional receiver, e.g. for protocol-related tasks, but instead, e.g., for at least one of reprogramming, field servicing, etc.

In some embodiments, asynchronous tags or tags without receivers may have a limited functionality since they are not configured to process commands, but they are configured to backscatter received signal(s) (e.g., as modified, e.g. frequency shifted, signal(s)), e.g. once they are energized.

In some embodiments, tags with receivers may have additional capabilities, e.g. to interpret received signals and/or to backscatter information, e.g. following a determined protocol.

In some embodiments, the exemplary configuration 1′ according to FIG. 11 represents an exemplary backscattering framework as can be provided using the principle according to the embodiments, wherein bi-static or multi-static backscattering communications can e.g. be enabled in a cellular communication environment.

In some embodiments, the illuminators 10-1, 10-2, 10-3 may include e.g. user equipment or base stations, e.g. gNB, and may illuminate the tags 20-1, 20-2, e.g. employing dedicated random access channel preambles D-RACH and e.g. RACH occasion(s), which, in some embodiments, may e.g. be provided by the receiving base station 30, e.g. via the first information I-1 exemplarily disclosed with reference to block 400 of FIG. 5 and block 612 of FIG. 9.

In some embodiments, FIG. 11, a single tag 20-1 may be illuminated by more than one illuminator 10-1, 10-2 (e.g., in the sense of a multi-static architecture), e.g. to enable diversity backscattering by the tag 20-1 and reception at the base station 30 as shown in FIG. 3.

In some embodiments, having several illuminators 10-1, 10-2 energize (e.g., using illuminator signals IS-1, IS-2) and query (e.g., using information signals INF-SIG-1, INF-SIG-2) a single tag 20-1 may reduce the probability of a deep fade in the illuminator-to-tag signal propagation path, thus e.g. increasing a decodability of the tag's backscattered information INF-SIG-1′, INF-SIG-2′ at the receiver base station 30.

In some embodiments according to FIG. 11, it is the second illuminator 10-2 that illuminates several tags 20-1, 20-2, e.g. at a same time as other illuminators 10-1, 10-3, thus e.g. increasing diversity gains for the backscattered information signals that may be received by the base station 30.

In some embodiments, from a tag's point of view, any random access channel preambles sent at a same time may result in a higher power density, e.g. to power the tag.

In some embodiments, after sending the random access channel preamble, e.g. in form of the illuminator signals, IS-1, IS-2, IS-3, the illuminators 10-1, 10-2, 10-3 may proceed to send a respective information signal INF-SIG-1, INF-SIG-2, INF-SIG-3 to at least one tag 20-1, 20-2, e.g. on a subcarrier within an allocated frequency for the dedicated random access channel preamble.

In some embodiments, some illuminators, e.g. each illuminator 10-1, 10-2, 10-3, may have a preconfigured subcarrier which it may employ for transmissions to the tags 20-1, 20-2.

In some embodiments, the preconfigured subcarrier may e.g. be preconfigured by the base station 30.

In some embodiments, a link budget for backscattering may be limited in a forward link (i.e., from an illuminator 10-1 to a tag 20-1), but not, or at least not to the same degree, from a tag 20-1 to the receiver base station 30 (reverse link), e.g. due to a comparatively high sensitivity of the base station 30.

In some embodiments, as mentioned above, the tags 20-1, 20-2 may be configured to perform a specific predetermined frequency shift of the information I-2, INF-SIG-1, INF-SIG-2, INF-SIG-3 they receive, which, in some embodiments, may e.g. be a subcarrier. In some embodiments, this allows to frequency multiplex readings, e.g. the modified information signals INF-SIG-1′, INF-SIG-2′, INF-SIG-3′, e.g. from different illuminators 10-1, 10-2, 10-3, in a single time resource such as e.g. a time slot.

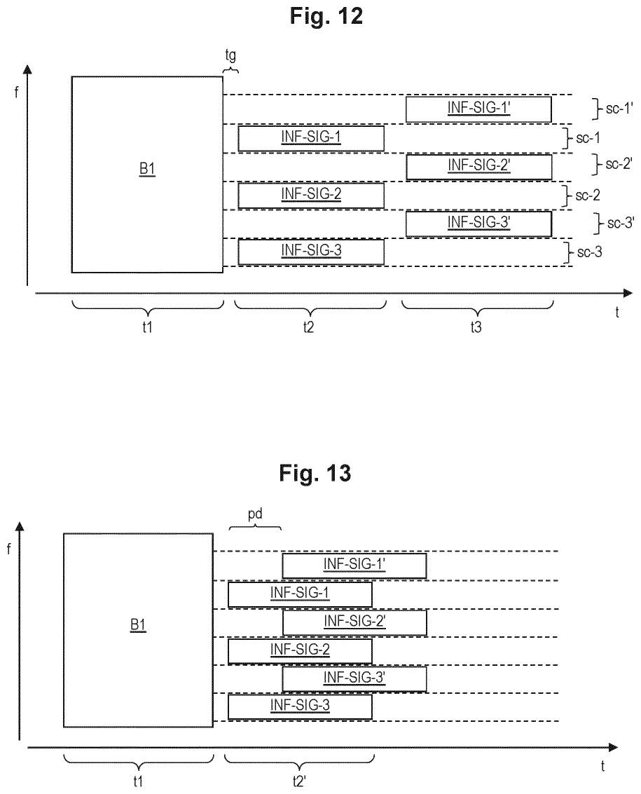

FIG. 12 schematically depicts a diagram according to further exemplary embodiments. Several, for example dedicated, radio access channel preambles as may be used by the illuminators 10-1, 10-2, 10-3 of FIG. 11, are symbolized by Block B1 in the time/frequency diagram of FIG. 12 having a horizontal time axis t and a vertical frequency axis f. In some embodiments, the preambles B1 may be based on constant amplitude zero autocorrelation, CAZAC, waveforms, e.g. as defined by some accepted standard.

In some embodiments, based on the preambles B1, the base station 30 may perform a random access channel detection, e.g. based on the CAZAC waveforms or their associated codes, respectively, e.g. to enable identification of individual illuminator(s) 10-1, 10-2, 10-3 and/or its respective location. In some embodiments, the random access channel detection may e.g. be performed in a time interval symbolized by the curled bracket t1 of FIG. 12.

In a second time interval t2, e.g. after a non-vanishing guard time tg, the illuminators 10-1, 10-2, 10-3 may transmit respective information signals INF-SIG-1, INF-SIG-2, INF-SIG-3, e.g. on specific subcarriers sc-1, sc-2, sc-3 (e.g. associated with their respective random access channel preambles), which may e.g. be decoded by the base station 30. In some embodiments, the base station 30 may use the information signals INF-SIG-1, INF-SIG-2, INF-SIG-3 for channel estimation of a respective radio channel between the illuminators 10-1, 10-2, 10-3 and the base station 30.

In a third time interval t3, the tags 20-1, 20-2 transmit modified information signals INF-SIG-1′, INF-SIG-2′, INF-SIG-3′, e.g. on specific subcarriers sc-1′, sc-2′, sc-3′, which are e.g. different from the subcarriers sc-1, sc-2, sc-3, whereby a frequency division multiplexing of the respective information signals is attained.

In some embodiments, the operation as exemplarily disclosed with reference to FIG. 12 may e.g. be based on tags 20-1, 20-2 that are equipped with a receiver.

FIG. 13 schematically depicts a diagram according to further exemplary embodiments, which is similar to FIG. 12. However, in contrast to the FIG. 12 configuration, FIG. 13 indicates that in a time interval t2′, the information signals INF-SIG-1, INF-SIG-2, INF-SIG-3 and their frequency-shifted associated modified information signals INF-SIG-1′, INF-SIG-2′, INF-SIG-3′ overlap along the time dimension t, e.g. by a propagation delay pd, which, however, does not affect a reception of the information signals INF-SIG-1, INF-SIG-2, INF-SIG-3 and their frequency-shifted associated modified information signals INF-SIG-1′, INF-SIG-2′, INF-SIG-3′, e.g. by the base station, due to the frequency division multiplex scheme according to some embodiments.

In some embodiments, the operation as exemplarily disclosed with reference to FIG. 13 may e.g. be based on tags 20-1, 20-2 that are not equipped with a receiver (e.g., backscattering operation).

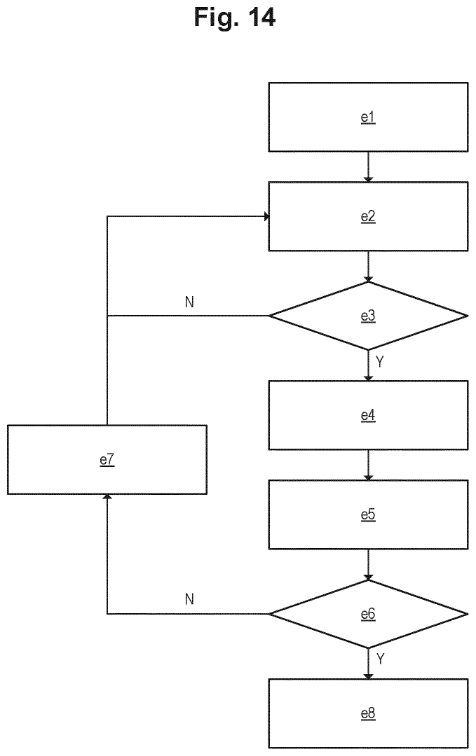

FIG. 14 schematically depicts a simplified flow chart according to some embodiments, e.g. illustrating at least some aspects performed by the base station 30.

Element e1 symbolizes the base station 30 (FIG. 11) allocating specific resources, e.g. for backscattering communications within the communication system 1′. In some embodiments, these resources may e.g. comprise at least one of: a) random access channel (RACH) occasions, e.g., frequency resources, time duration and periodicity of these resources, b) dedicated preambles per illuminator to use during the stated RACH occasions, c) frequency resources, e.g. subcarrier, within the RACH resources to be employed, e.g. in a time contiguous slot, e.g. for information transmission.

Element e2 symbolizes the base station 30 receiving a random access channel preamble assigned to a terminal device. Element e3 symbolizes the base station 30 determining whether the received random access channel preamble is associated with at least one illuminator.

Element e4 symbolizes the base station 30 receiving, for example decoding, a first transmission on a first subcarrier associated with the received preamble.

Element e5 symbolizes the base station 30 receiving, for example decoding, a second transmission on a second subcarrier associated with the first subcarrier.

Element e6 symbolizes the base station 30 determining whether the received preamble has been allocated by the base station 30. If so, the base station 30 may send a message to the illuminator associated with the first and second transmissions, e.g. along with other, optional, supplementary information, such as e.g. localization information and/or next procedures to be executed by the illuminator, see element e8.

If the determination of element e6 yields that the illuminator preamble received according to element e2 was not allocated by the base station 30, the base station 30 may e.g. forward the received preamble, information related to the first and second transmissions, and, optionally, other supplementary information (e.g. time of arrival) to a network device or node which has allocated the received preamble, e.g. for joint decoding purposes or localization, see element e7.

In some embodiments, if the determination of element e3 yields that the received random access channel preamble is not associated with at least one illuminator, the procedure may continue with element e2.

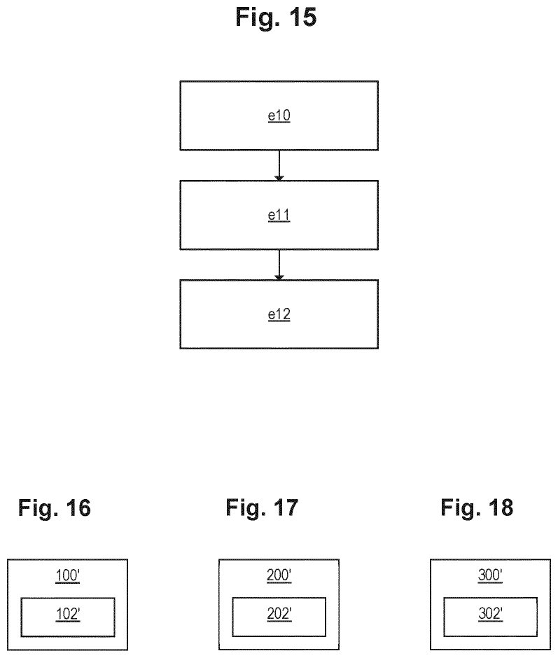

FIG. 15 schematically depicts a simplified flow chart according to some embodiments, e.g. illustrating aspects performed by an illuminator 10.

Element e10 symbolizes the illuminator 10 employing an assigned dedicated random access channel preamble to illuminate one or more tags 20, 20-1, 20-2. Element e11 symbolizes the illuminator 10 transmitting a set of information (e.g., the information signal INF-SIG), e.g. on a subcarrier associated with the preamble and provided by the receiving base station 30, e.g. after the preamble transmission. Element e12 symbolizes the illuminator receiving a message from the receiving base station 30 (e.g., at least similar to the third information I-3 according to block 406 of FIG. 5), e.g. confirming a reception of the preamble along with the transmission performed by the illuminator in element ell, and the backscattering signal INF-SIG′ or decoded signal from the one or more tags. In some embodiments, in element e12, the illuminator may also, optionally, receive additional, e. g. supplemental, information, such as information characterizing a localization of the base station 30 and/or the one or more tags.

In some embodiments, the receiver base station 30 may be configured to not permanently reserve resources, e.g. for a transmission, e.g. of an information signal INF-SIG, e.g. after detecting a dedicated random access channel preamble, if e.g. a RACH occasion is shared for other purposes, or if the receiver base station 30 configures the illuminators to inform the receiving base station(s) of its intention to perform a backscattering query via e.g. a scheduling request or some other medium access control control element (MAC CE). In some embodiments, this may further reduce an overhead that may be caused by backscattering communications INF-SIG-1′, INF-SIG-2′, . . . in the wireless communication system 1′.

In some embodiments, when a receiver base station 30 is aware that a backscattering communication using one or more tags 20, 20-1, 20-2 is to be performed, it may instruct one or more additional illuminators 10-2, 10-3, e.g. via level 1 (L1) signaling (e.g., PDCCH, physical downlink control channel) and/or via level 2 (L2) signaling (e.g., using MAC CE commands) to initiate a backscattering operation in a determined geographical area, e.g. for additional diversity gains.

In some embodiments, a localization of the receiver base station 30 and of the tags 20, 20-1, 20-2 can e.g. be obtained based on increasing a number of receiver base stations 30 in a specific area.

As an example, in some embodiments, indoor deployments may have base stations with an inter-site distance of about 20 meters. Considering a typical backscattering link budget and employing indoor propagation models according to some accepted standard, such as e.g. 3GPP indoor propagation models, e.g. for a line-of-sight (LOS) scenario, a tag 20 may be up to 37 meters away from an illuminator 10 to be detected by the receiver base station 30 in 95% of the cases. In some embodiments, for a non-LOS scenario, this range may be reduced to approximately 9 meters, which, in some examples, does not consider uplink receiver combining techniques. In some embodiments, with the exemplary ranges specified as above, the illuminator and tag information may e.g. be received by more than one base station 30.

The principle according to the embodiments enables backscattering communication using one or more tags 20, 20-1, 20-2, e.g. in frequency division duplexing configurations, e.g. according to some accepted standard, where, for example, at least some network devices such as base stations may not be configured to transmit on an uplink part of a used frequency band. In some exemplary embodiments, one or more terminal devices 10′, e.g. user equipment 10″, may be used as illuminator(s) 10.

In some embodiments, the base station 30 may allocate a RACH resource, e.g. with configurable periodicity, for backscattering. In addition, in some embodiments, a second resource contiguous in time may be reserved by the base station 30, e.g. to receive modified information signals INF-SIG-1′, . . . from the illuminator(s) 10, 10-1, . . . and the tags 20, 20-1, . . . In some embodiments, a duration of the second contiguous resource may depend on the modified information signals INF-SIG-1′, . . . and may hence be smaller or larger than a standard time resource such as e.g. a time slot. In some embodiments, duration of the second contiguous resource may depend on a specific application.

In some embodiments, the RACH resources and preambles may employ existing L1 specified formats, or a new format may be designed, e.g. for higher efficiency.

The principle according to the embodiments allows for a scalable design of resources allocated for backscattering devices, i.e. tags, enabling e.g. a single RACH occasion to be employed for a plurality, e.g. many, tags (e.g. 64 with current specifications according to some accepted standard), e.g. in a single area.

In some embodiments, the usage of dedicated RACH preambles allows for localization of at least one illuminator 10, which may e.g. be helpful in scenarios, in which the at least one illuminator 10 is a user equipment, and a specific tag 20 has to be queried in a specific area.

In some embodiments, furthermore, given a known relationship between a) the RACH preamble employed by the illuminator, b) the information signal INF-SIG transmitted to the tag 20 and c) the backscattered signal, i.e. modified information signal INF-SIG′, from the tag 20, a localization of the tag 20 is also possible, e.g. if more than one receiver can decode the signals (e.g. with trilateration). In some embodiments, a localization of the tag 20 depends on a deployment scenario and an inter-site distance of the deployed base stations. Alternatively, in some embodiments, a single base station 30 can localize the tag 20 when the base station 30 utilizes multiple antennas (e.g. with Angle of Arrival (AoA) methods or Angle of Departure (AoD) methods). In some embodiments, combining range information and angle information may also be used for positioning.

In some embodiments, providing a tag illumination, i.e. radio frequency signals, on a comparatively large bandwidth may not only enable a higher ranging resolution, but may also allow a higher power density to power up the tag.

In some embodiments, for an operation of the tag related to receiving and modifying information signals INF-SIG, a comparatively small bandwidth may allow to filter out noise and to concentrate a limited power of the tag 20 to e.g. reduced resources, e.g. for better decoding probability at the receiver base station 30. In some embodiments, when a smaller bandwidth is used, a ranging resolution may degrade, but, in some embodiments, multiple antennas at the base station can be leveraged to perform angular positioning.

At least some exemplary embodiments, wherein terminal devices 10′ are used as illuminators, attain the advantage that no complex circuitry is required to maintain a synchronization of the tag 20 with the receiving base station 30, because the terminal devices 10′ already possess the capability of maintaining a synchronization with the network, e.g. network device 30.

In the following, exemplary aspects and embodiments related to an out-of-band operation according to further exemplary embodiments are explained.

Some exemplary embodiments may e.g. be used for in-band coexistence, e.g. of backscattering signals INF-SIG', . . . associated with the tag(s) 20, 20-1, 20-2 and a radio access technology (RAT), e.g. of the wireless communication network 1, 1′, such as e.g. a RAT according to some accepted standard, e.g. a 3GPP RAT.

In some embodiments, an out-of-band operation may be explored, e.g. for frequency bands which may not suffer from excessive additional power reductions, e.g. due to the out-of-band operation.

In some embodiments, e.g. when co-existing with networks according to some accepted standard, such as e.g. 3GPP 5G, a potential overhead imposed by a backscattering approach according to some embodiments may be accounted for. In some examples, one approach to reduce, e.g. minimize, the overhead may e.g. provide positioning a bandwidth used for backscattering signals out of a frequency channel allocated for wireless communications of the network, e.g. 3GPP network.

In some embodiments, e.g. if at least one user equipment 10″ acts as an illuminator 10, the at least one user equipment 10″ may e.g. reduce its maximum transmission power used for transmitting illuminator signals IS, e.g. to comply with regulatory emission masks for out-of-band emissions.

In the following, further exemplary aspects and advantages according to at least some exemplary embodiments are explained.

Some embodiments enable to provide a simple scalable solution to enable backscattering communications using tags 20, e.g. in conventional wireless, e.g. cellular, communication networks.

Some embodiments enable to provide a solution which can interwork, e.g. with 4G and 5G networks, and which may e.g. be accommodated in 6G and future networks, thus offering a backscattering communication framework virtually without an end of life cycle, which may facilitate deployment in many technical fields such as e.g. automotive and other fields, where life spans of corresponding articles of manufacture (e.g., cars) are greater than evolutionary cycles of conventional wireless communications networks.

Some embodiments enable to reuse an existing infrastructure, such as e.g. base stations 30, for receiving backscattered signals INF-SIG′ from one or more tags 20, so that no further readers for receiving the backscattered signals are to be provided.

Some embodiments enable to use tags with comparatively low complexity, e.g. enabling the tags to transmit, e.g. scatter, e.g. backscatter, a frequency-shifted and/or otherwise modified version INF-SIG′ of a received information signal INF-SIG. In some examples, this enables to keep costs of the tags low.

Some embodiments enable to use illuminators with a comparatively low complexity, e.g. as compared with existing terminal devices such as user equipment, because conventional random access channel preambles can e.g. be used as illuminator signals IS.

In some embodiments, localization can be supported, e.g. for the receiving network device 30 and/or the tags 20.

In some embodiments, the principle according to the embodiments may e.g. be used for sensing applications, e.g. for vertical farming and the like. As an example, in some embodiments, at least one illuminator 10 (FIG. 3) may be mounted on a vehicle, e.g. an uncrewed aerial vehicle (UAV), e.g. a drone, whereby a mobile illuminator can be provided which can e.g. selectively illuminate different tags, which may e.g. be associated with different components of the sensing application, e.g. vertical farm. In some embodiments, a server, e.g. edge server or cloud-based server, may be provided, e.g. to control the illuminator and/or the UAV.

In some embodiments, e.g. compared to a mono-static architecture, a bi-static (or multi-static) architecture as proposed is comparatively power efficient, e.g. in terms of powering a tag and maximizing a backscattering link budget range.

1. An apparatus, comprising at least one processor, and at least one memory storing instructions, the at least one memory and the instructions configured to, with the at least one processor, cause an illuminator for illuminating at least one tag with a radio frequency signal to transmit an illuminator signal to the at least one tag based on a dedicated random access channel preamble associated with the illuminator.

2. The apparatus according to claim 1, wherein the instructions, when executed by the at least one processor, further cause the illuminator to receive from a network device a first information characterizing at least one of: a) a configuration of random access channel resources, b) the dedicated random access channel preamble associated with the illuminator.

3. The apparatus according to claim 1, wherein the instructions, when executed by the at least one processor, further cause the illuminator to transmit second information on a resource associated with the dedicated random access channel preamble associated with the illuminator.

4. The apparatus according to claim 1, wherein the instructions, when executed by the at least one processor, further cause the illuminator to receive third information characterizing at least one of: a) a reception of the dedicated random access channel preamble associated with the illuminator by a network device, b) the second information location information of at least one of the network device and the at least one tag.

5. A method comprising: transmitting, by an illuminator for illuminating at least one tag with a radio frequency signal, an illuminator signal to the at least one tag based on a dedicated random access channel preamble associated with the illuminator.

6. (canceled)

7. An apparatus, comprising circuitry configured to cause a tag for receiving a radio frequency signal to receive at least one illuminator signal from at least one illuminator for illuminating at least one tag with a radio frequency signal, wherein the at least one illuminator signal is based on a dedicated random access channel preamble associated with the at least one illuminator.

8. The apparatus according to claim 7, wherein the circuitry further causes the tag to use a power associated with the at least one illuminator signal for powering an operation of the tag

9. The apparatus according to claim 7, wherein the circuity further causes the tag to receive at least one information signal from the at least one illuminator, to modify the at least one information signal by applying at least one of a frequency shift and a modulation to the at least one information signal, and to transmit at least one modified information signal.

10.-11. (canceled)

12. An apparatus, comprising at least one processor, and at least one memory storing instructions, the at least one memory and the instructions configured to, with the at least one processor, cause a network device to receive a modified information signal from at least one tag, wherein the modified information signal is based on at least one information signal transmitted from at least one illuminator for illuminating the at least one tag on a resource associated with a dedicated random access channel preamble associated with the at least one illuminator.

13. The apparatus according to claim 12, wherein the instructions , when executed by the at least one processor, further cause the network device to transmit third information characterizing at least one of: a) a reception of the dedicated random access channel preamble associated with the illuminator by a network device, b) the second information, c) location information of at least one of the network device and the at least one tag to the at least one illuminator.

14. The apparatus according to claim 12, wherein the instructions, when executed by the at least one processor, further cause the network device to allocate random access channel resources and the at least one dedicated random access channel preamble to the at least one illuminator.

15. The apparatus according to claim 12, wherein the dedicated random access channel preamble is dedicated in a given spatial region.

16. The apparatus according to claim 14, wherein the instructions), when executed by the at least one processor, further cause the network device to transmit first information to the at least one illuminator, the first information characterizing at least one of: a) a configuration of random access channel resources, b) the dedicated random access channel preamble associated with the illuminator.

17. The apparatus according to claim 12, wherein the instructions, when executed by the at least one processor, further cause the network device to perform at least one of: a) receiving a dedicated random access channel preamble on a first resource, b) receiving an information signal from the at least one illuminator on a second resource, c) receiving a modified information signal from the at least one tag on a third resource.

18. The apparatus according to claim 17, wherein at least two of the first resources, the second resources and the third resources at least partially overlap in at least one of a time dimension and a frequency dimension.

19.-24. (canceled)
